(19) United States
(12) Patent Application Publication
(10) Pub. No.: US 2002/0101084 A1
(43) Pub. Date: Aug. 1, 2002

(54) Apparatus and methods for opening a vehicle hood

(76) Inventor: Bradley R. Weschler, Huntington Station, NY (US)

Correspondence Address: Daniel P. Burke, Esq., Galgano & Burke, 300 Rabro Drive - Suite 135, Hauppauge, NY, 11788, US

(21) Appl. No.: 10/106,133

(22) Filed: Mar. 25, 2002

Related U.S. Application Data
(63) Continuation-in-part of application No. 09/584,284, filed on May 31, 2000, now Pat. No. 6,361,091.

(51) Int. Cl. E05B 3/00

(52) U.S. Cl. 292/336.3

(57) ABSTRACT

Devices and methods of releasing engine compartment hoods, designed to be used in conjunction with vehicles equipped with passenger compartment hood releases allow a hood to be released from outside the vehicle. The disclosed devices are positioned between an existing lock assembly and the protective sheath of the existing release cable.

### RELATED APPLICATION DATE

The present invention relates to apparatus and methods for opening the hood of a vehicle and, are particularly useful for auto body repair persons who must typically open and close a vehicle hood many times during the course of certain repairs.

This application is a continuation-in-part of U.S. patent application Ser. No. 09/584,284 which issued as U.S. Pat. No. 6,361,091 on Mar. 26, 2002.

### BACKGROUND

Those skilled in the art of auto body repair will appreciate that a vehicle hood, i.e. the movable cover which provides access to an engine compartment must typically be opened and closed many times in order to effect proper fit and alignment of the hood and its adjacent panels. Each time the hood is opened and closed, it is necessary for the auto body repair technician to walk around to the interior of the car in order to release the hood. Alternatively, a second technician must be utilized to sit within the car and open the hood release each time the hood is opened and closed. In either case, repair of a hood and its adjacent panels is made more tedious and time-consuming by the need for tripping the hood release while effecting the vehicle repair.

It is therefore desirable to provide a hood release for a conventional vehicle which can be readily used with many vehicles, which is relatively inexpensive, and which allows a single auto body repair technician to open the hood of a vehicle from the front of the vehicle and without requiring a trip to the interior passenger compartment or an assistant.

### BRIEF DESCRIPTION OF THE DRAWINGS

FIG. 1 is an exploded view of a supplemental vehicle hood release of one embodiment of the present invention.

FIG. 2 is a side perspective view of the embodiment shown in FIG. 1 in a non-actuated position.

FIG. 3 is a side view of the embodiment of the present invention shown in FIG. 1 in an actuated position.

FIGS. 4A-4D illustrate portions of a conventional vehicle hood lock mechanism and the insertion and use of the supplemental vehicle hood release shown in FIG. 2.

FIG. 5 illustrates a further embodiment of the present invention.

FIG. 6 illustrates a still further embodiment of the present invention.

FIG. 7 is a perspective view of another embodiment of the present invention and a partial view of a vehicle hood lock assembly cable.

FIG. 8 is a cross-sectional view of the embodiment shown in FIG. 7.

FIG. 9 is a perspective view of the bracket and slider assembly of the embodiment shown in FIG. 7.

FIGS. 10-12 are top side and bottom views of the bracket and slider assembly shown in FIG. 9.

FIG. 13 is a perspective view of the bracket shown in FIG. 9.

### DETAILED DESCRIPTION

The various embodiments of the present invention comprise methods and devices for releasing the lock assembly of a vehicle hood from a location proximate the front of the vehicle. Those skilled in the art of auto body repair will appreciate that a vehicle hood release typically comprises a hood lock assembly, a release cable having a proximal end connected to a handle located within the passenger compartment of the vehicle and a terminal end operatively connected to a hood lock assembly, a cable cover comprising a sheath and one or more terminal end attachments disposed over substantially the entire length of the cable leaving a terminal portion of the cable exposed. A terminal end of the sheath or protective attachment members of the cable cover are spaced from the terminal end of the actual cable. Typically, a support attached to the vehicle abuts the terminal end of the cable cover. In order to release the hood lock assembly, a person must typically pull the handle located within the passenger compartment of the vehicle causing the cable to move relative to the terminal end of the cable cover and thereby tripping the hood release mechanism. This typical hood release does not rely upon movement of the cable cover, however, sufficient movement of the cable cover can be used to release the hood lock since most vehicle specifications allow only a minimum amount of play between the cable cover and the cable. Therefore, if the cable cover is moved in the same direction that the cable is usually drawn when releasing the hood, the movement of the protective cover will cause the cable to move thereby tripping the hood release mechanism. The various embodiments of the present invention operate on the principle that movement of the cable sheath or other portions of the cable cover will effect movement of the terminal end of the cable to release the vehicle hood.

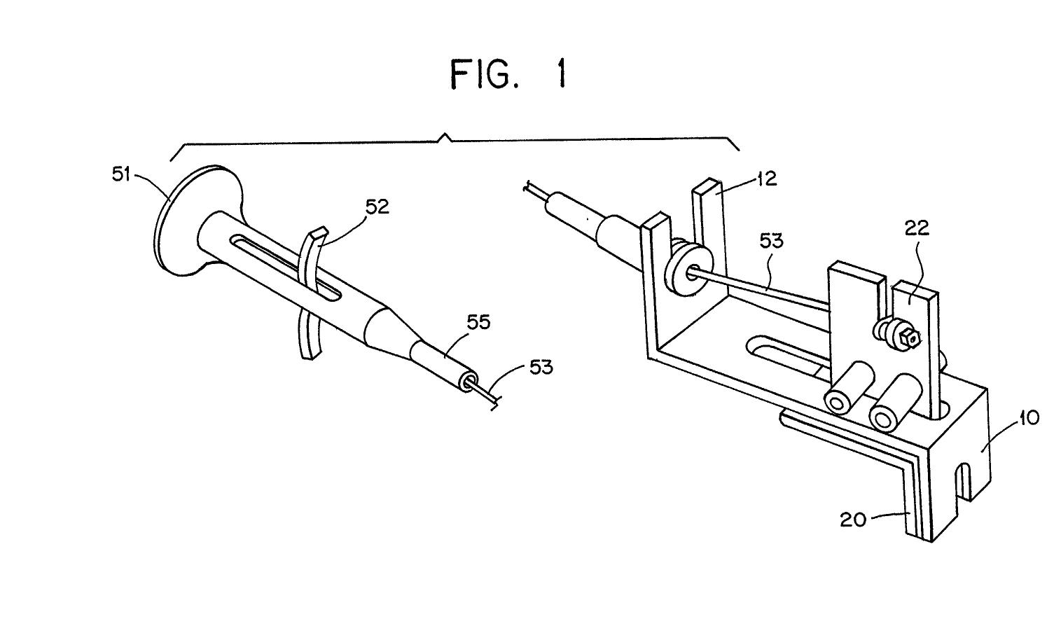

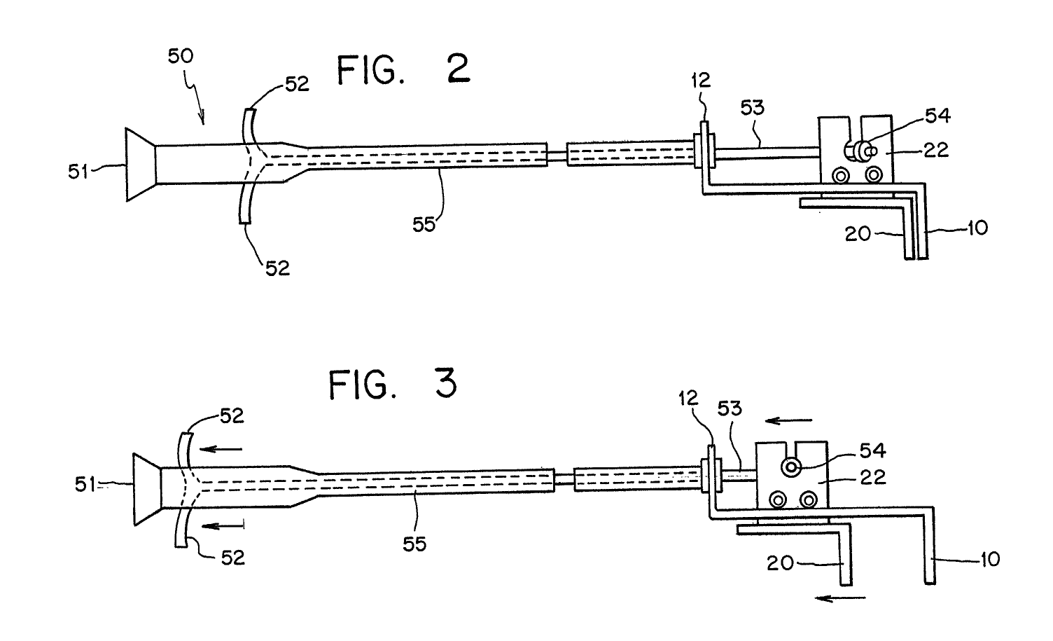

One embodiment of the present invention is illustrated FIGS. 1 to 3 wherein a first member 10 and a second member 20 are selectively movable relative to each other by a remote, manually operated actuator 50. The manually operated actuator comprises a base 51, finger grips 52, a cable 53 having a terminal end 54 and a cable cover 55. The proximal end of the cable 53 is attached to the finger grips 52 while the proximal end of the cable cover or sheath 55 is connected to the base 51. In this illustrated embodiment, the base 51 is integrally molded with the cable cover 55, however, from the present description, one skilled in the art will appreciate that these pieces can be manufactured separately. The terminal end 54 of the cable 53 is connected to a portion of second member 20 while the terminal end of the cable cover 55 is connected to a flange 12 on the first member 10.

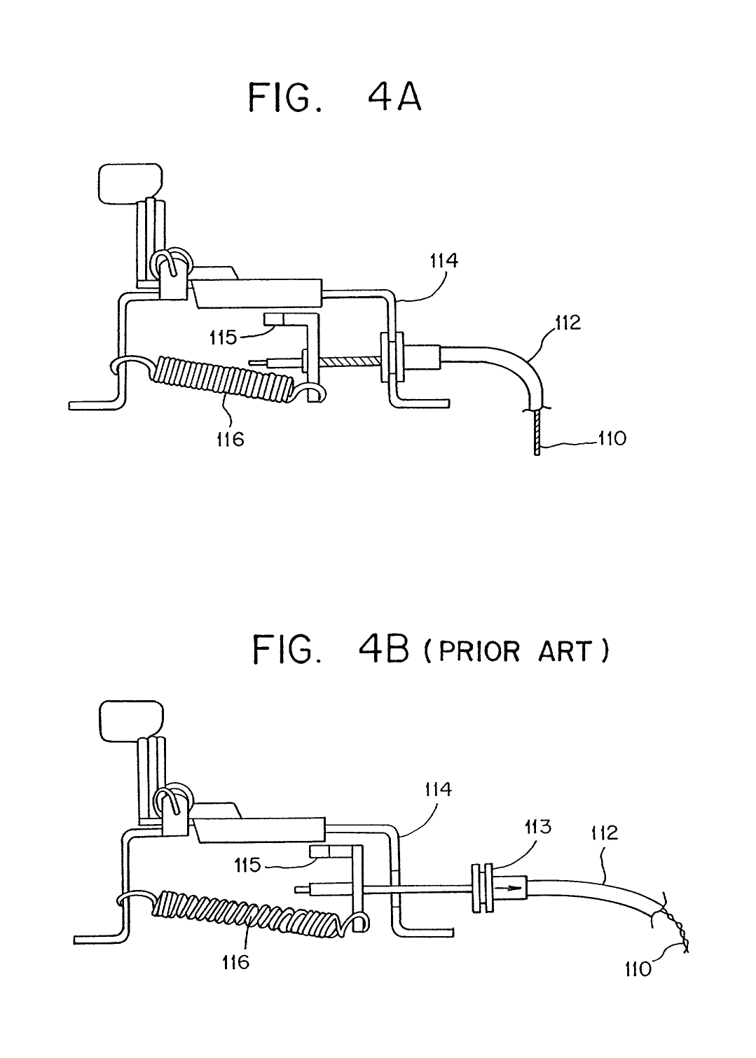

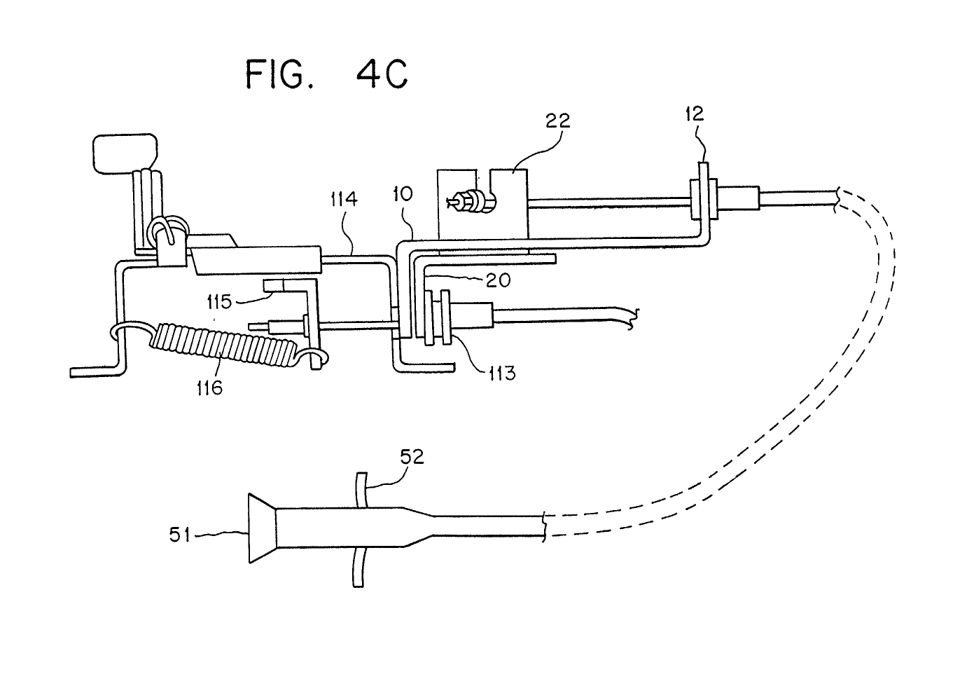

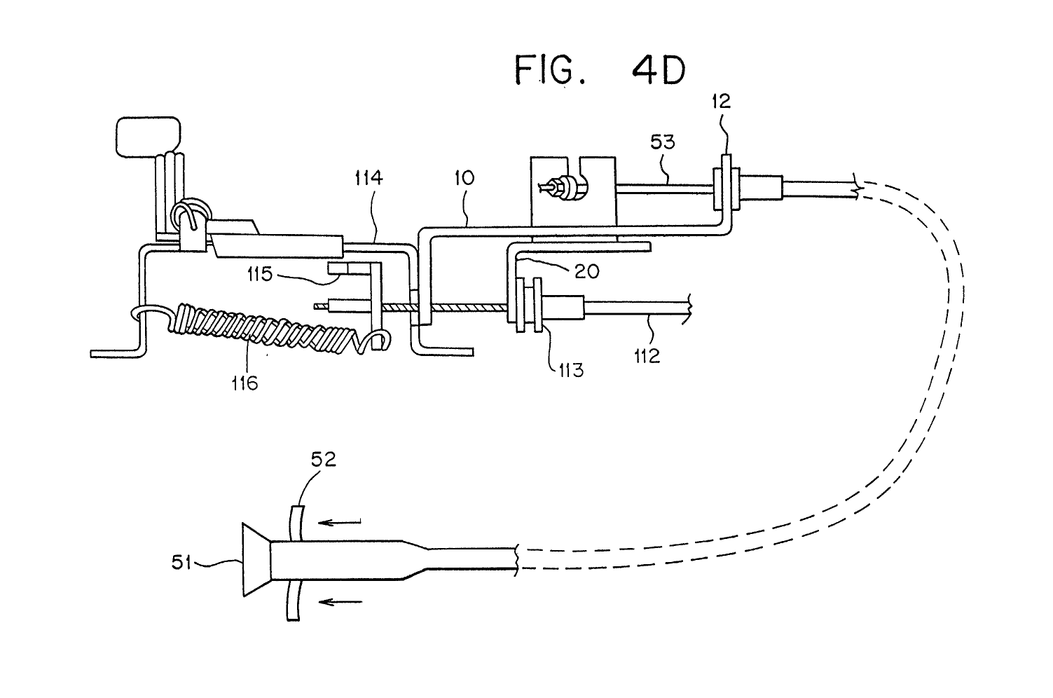

FIG. 4A illustrates portions of a vehicle lock assembly wherein a conventional cable 110 and a sheath 112 are connected to a bracket 114. When a person desires to open this hood in a conventional manner, the hood release in a vehicle (not shown) is pulled causing cable 110 to move to the right in this illustrated embodiment thereby moving hood release member 115 in a manner which trips the hood release. When the person releases the hood release lever in the passenger compartment, spring 116 draws the hood release mechanism back toward the left in the illustration. FIG. 4A therefore illustrates portions of a conventional vehicle hood release mechanism.

In order to install the supplemental hood release mechanism of the present invention, the sheath 112 and terminal connector 113 are disconnected from support bracket 114 as illustrated in FIG. 4B and relatively movable elements 10 and 20 are inserted over the portion of the cable between support bracket 114 and the terminal connector 113 located on the end of sheath 112. The supplemental hood release of this embodiment of the present invention is now in position for actuation. As illustrated in FIGS. 4C and 4D, movement of the finger grips 52 relative to base 51 on the supplemental hood release will cause sheath 112 to be moved to the right in this illustration. After the minimal amount of play existing between cable 110 and sheath 112 has been eliminated, movement of the sheath 112 to the right will cause cable 110 to also move to the right. Those skilled in the art will appreciate that sufficient movement of cable 110 to the right will cause sufficient movement of hood lock release member 115 thereby tripping the hood release. The amount of movement required to trip a hood release may vary between different vehicles and therefore the movement provided by a supplemental hood release of the present invention can also be used to provide different amounts of movement. However, a typical supplemental hood release may move a conventional hood release cable sheath about 1/16 inch to about 3 inches, more preferably about ⅛ inch to about ¾ inch, or most preferably about ¼ inch to about ½ inch.

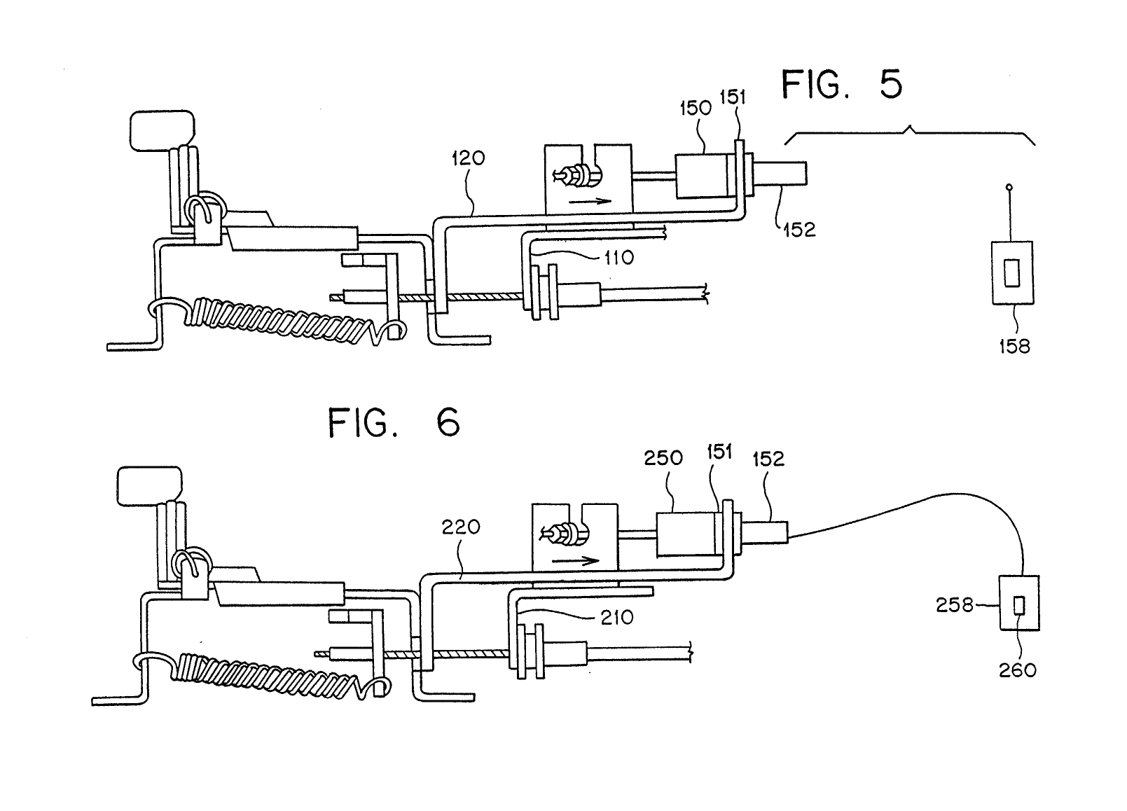

While the preferred illustrated embodiment shown in FIGS. 1 to 3 relies upon a manual actuator for causing movement between the first member 10 and the second member 20, alternative embodiments of the present invention rely upon other mechanisms for causing this relative movement. FIG. 5 illustrates an electronic actuator comprising a solenoid 150, a battery pack 151, and a radio frequency receiver 152. When a signal is generated by remotely operated radio transmitter 158, a signal is received by the actuator 150 causing the solenoid 150 to move second element 120 away from first element 110 with the same effect as discussed above with reference to the embodiment of FIGS. 1 to 3.

According to a still further embodiment of the present invention, illustrated in FIG. 6, a signal transmitter 258 is hard wired to an electronic actuator comprising a solenoid 250. In this embodiment, the push of button 260 on remote control 258 causes the solenoid 250 to move second element 220 relative to first element 210.

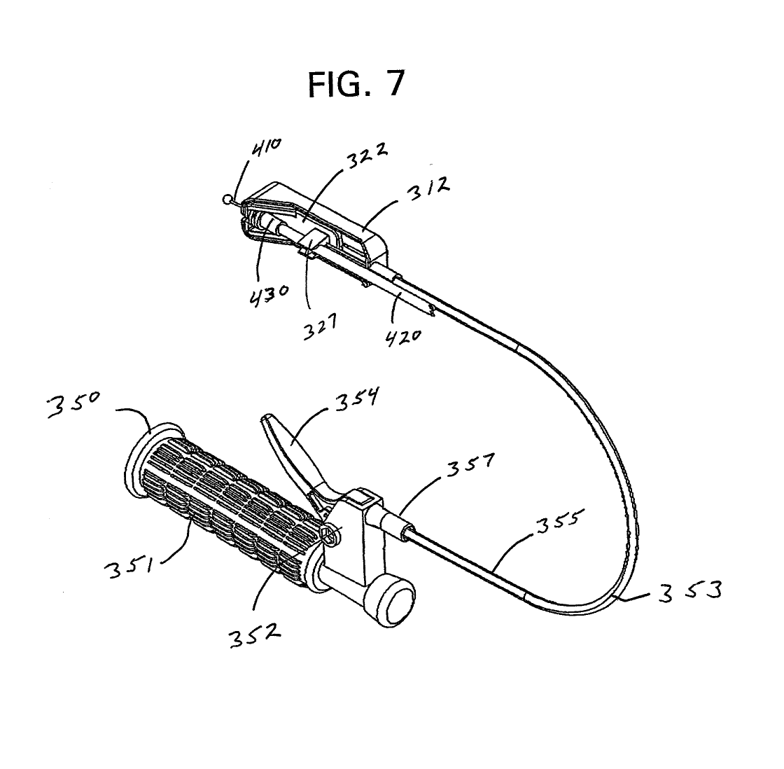

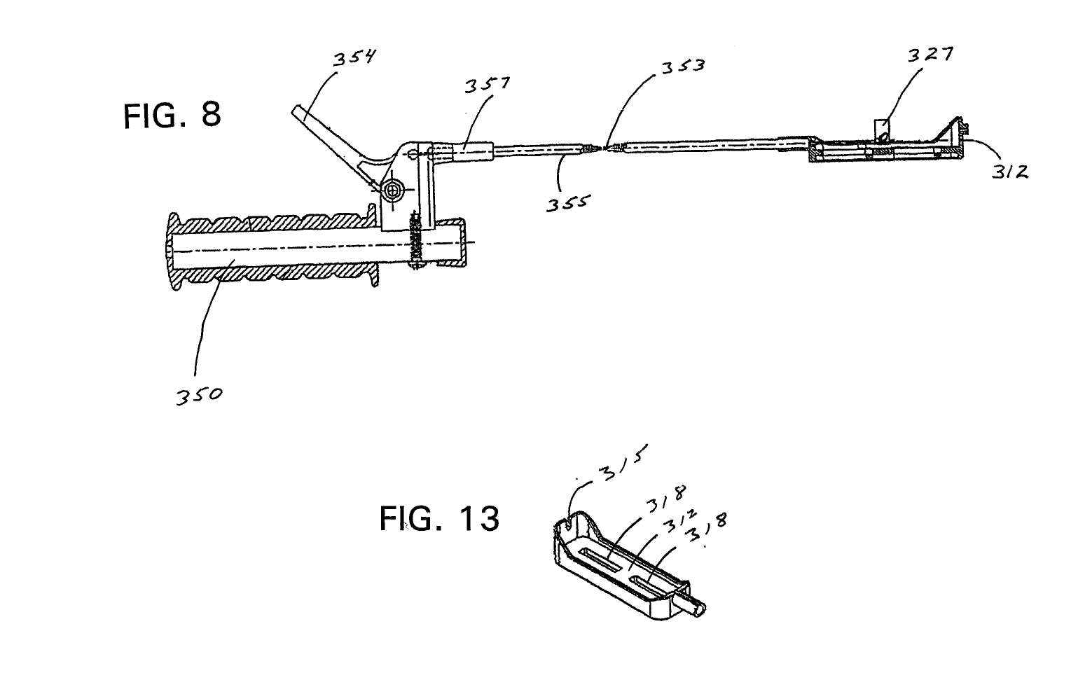

One preferred embodiment of the present invention is illustrated in FIGS. 7-13. With reference to FIG. 7, this preferred embodiment comprises a handle 350 which is preferably formed in a dimension similar to a bicycle handle grip and comprises resilient fins 351. Mounted on the handle 350 is a trigger assembly 352 comprising a trigger 354 which is operatively connected to a cable 353 slidably disposed within cable sheath 355. As best shown in FIG. 8, the proximal end, i.e., the end closest to the handle 350, of cable 353 comprises a cable fitting 356 generally in the form of a ball which is linked to trigger 354. The proximal end of cable sheath 355 is connected to the cable assembly 352 by a conduit fitting 357. In this manner, the cable 353 is movable relative to cable sheath 355 by moving trigger 354 relative to handle 350.

The distal end of cable sheath 355 is connected to bracket 312 while the distal end of cable 353 is connected to slider 322 which is slidingly connected to bracket 312. The distal end of cable 353 also comprises a generally spherical cable fitting, which is received in a spherical opening 328 of slider 322 (best shown in FIG. 10.). Therefore, when trigger 354 is squeezed closer to handle 350, slider 322 is moved proximally relative to bracket 312, i.e. along the direction of the cable 353 toward handle 350.

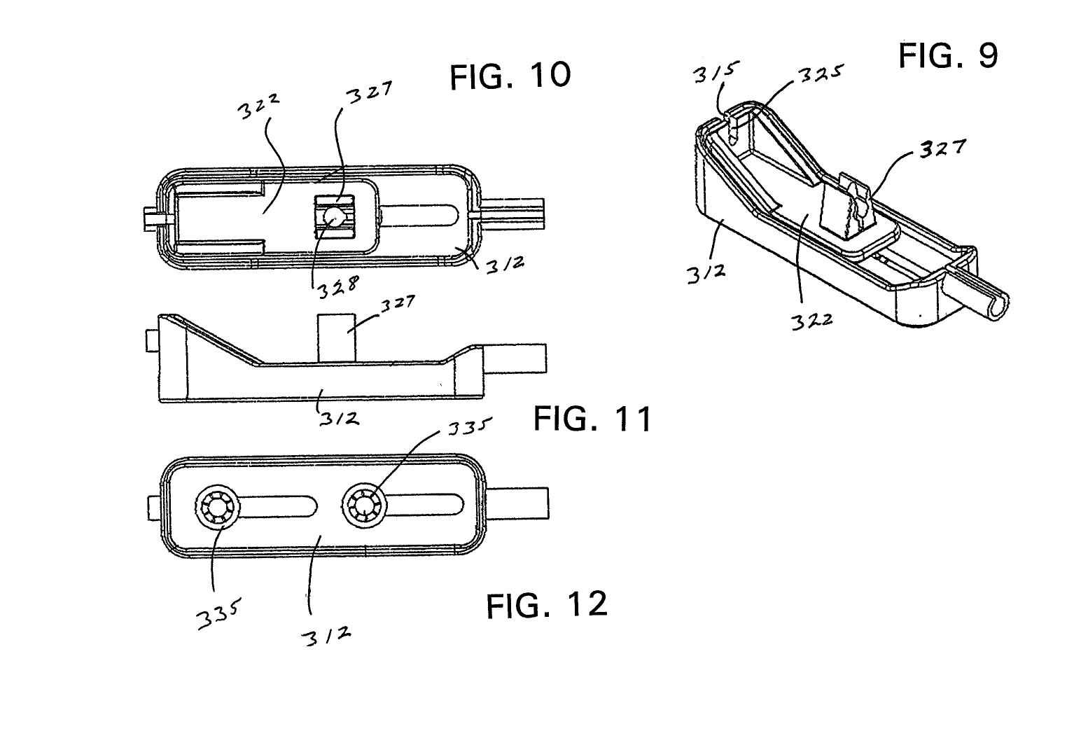

With reference to FIG. 9, slider 322 comprises a distal slot 325 dimensioned to receive a cable from a conventional vehicle hood lock release mechanism. Bracket 312 also comprises a proximal slot 315 which is aligned with slot 325 of slider 322. Slider 322 of this illustrated embodiment also comprises an integrally molded, resilient bracket 327. FIG. 7 illustrates a partial view of a conventional cable assembly from a typical vehicle hood release mechanism comprising a cable 410, cable sheath 420 and terminal cable sheath fitting 430. Those skilled in the art will appreciate that terminal cable sheath fitting 430 of a vehicle hood release cable is typically connected to or abutted against a support or bracket of the vehicle. This embodiment of the present invention is designed to position the terminal ends of both bracket 312 and slider 322 between the terminal cable fitting 430 and the support of the vehicle with the cable 410 passing through slots 315 and 325 of the bracket and slider, respectively. The cable sheath 420 is preferably positioned in an integrally molded, resilient bracket 327. This embodiment of the present invention is designed for relatively quick connection to an existing vehicle's hood release mechanism and, from the present description, those skilled in the art will appreciate that by squeezing trigger 354 closer to handle 350, the sheath of the vehicle's existing hood release cable will be drawn away from the support sufficiently to cause the cable 410 to be moved enough to trip the hood release allowing the hood to be opened.

FIGS. 10, 11 and 12 are top, side and bottom views of the bracket 312 and slider 322. The bottom view of FIG. 12 shows connectors 335 used to slidingly connect slider 322 to bracket 312 within a pair of parallel slots. The slots 318 are clearly illustrated in the perspective view of FIG. 13.

Other embodiments of the present invention comprise methods for releasing an engine compartment hood on a vehicle which comprises as standard equipment a hood lock assembly, a release cable comprising a proximal end located proximate a passenger compartment and a terminal end operatively connected to the hood lock assembly, a cable comprising a terminal end spaced from the cable terminal end, and a support abutting the terminal end of the cover. The method comprises the steps of positioning a first member and second member which is movably positioned relative to the first member between the terminal end of the cable cover and the support, and causing the second member to move relative to the first member sufficiently to release the vehicle hood.

1. A supplemental vehicle hood release for use on a conventional vehicle hood lock assembly comprising a release cable comprising a proximal end located proximate a passenger compartment and a terminal end operatively connected to said hood lock assembly, a cable cover comprising a terminal end spaced from said cable terminal end, and a support contacting said terminal end of said cover, said supplemental vehicle hood release comprising:
a bracket;
a slider movably positioned relative to said bracket; and
means for selectively moving said slider relative to said bracket, wherein at least a portion of bracket and said slider are positioned between said cover terminal end and said support, and sufficient movement of said cover terminal end releases the vehicle hood.

2. A supplemental vehicle hood release according to claim 1 wherein said slider comprises a resilient bracket for releasably connecting said slider to the cable of the conventional vehicle hood lock assembly.

3. A supplemental vehicle hood release according to claim 2 wherein said moving means comprises a trigger assembly connected to a cable.

4. A supplemental vehicle hood release according to claim 1 wherein said moving means comprises:
a cable comprising a proximal end and a distal, terminal end operatively connected to said slider;
a cable cover comprising a proximal end and a distal, terminal end operatively connected to said bracket; and
a trigger assembly connected to said proximal end of said cable and said proximal end of said cable cover for moving said cable relative to said cover.

5. A supplemental vehicle hood release according to claim 5 wherein said trigger assembly is manually operated.

6. A supplemental vehicle hood release according to claim 1 wherein said moving means is manually operated.

7. A supplemental vehicle hood release according to claim 6 comprising a signal transmitter and a signal receiver.

8. A supplemental vehicle hood release according to claim 7 wherein said signal is a radio frequency signal.

9. A supplemental vehicle hood release according to claim 1 wherein said moving means comprises a solenoid.
